(19) United States
(12) Patent Application Publication
(10) Pub. No.: US 2010/0177082 A1
(43) Pub. Date: Jul. 15, 2010

(54) GATE DRIVING CIRCUIT AND DISPLAY APPARATUS HAVING THE SAME

(76) Inventors: Soong-Yong Joo, Seongnam-si (KR); Hyoung-Sik Moon, Suwon-si (KR); Dong-Yub Lee, Siheung-si (KR)

Correspondence Address: F. CHAU & ASSOCIATES, LLC, 130 WOODBURY ROAD, WOODBURY, NY, 11797, US

(21) Appl. No.: 12/534,403

(22) Filed: Aug. 3, 2009

(30) Foreign Application Priority Data
Jan. 13, 2009 (KR) 2009-2714

(51) Int. Cl. G09G 5/00; G09G 3/36

(52) U.S. Cl. 345/211; 345/87

(57) ABSTRACT

A gate driving circuit includes a shift register in which the stages are connected to each other one after another. An m-th stage includes a pull-up section outputting a high voltage of a first clock signal as a gate signal in response to a voltage of a first node, a pull-down section pulling down the gate signal to an off voltage in response to the first clock signal or the second clock signal, a driving section turning on and turning off the pull-up section and a holding section maintaining a voltage of the first node at the off voltage in response to the first clock signal, and a voltage maintenance section blocking a leakage current through the pull-up driving section and the holding section during an output interval of the gate signal to delay a voltage drop of the first node.

### PRIORITY STATEMENT

This application claims priority under 35 U.S.C. §119 to Korean Patent Application No. 2009-2714, filed on Jan. 13, 2009 in the Korean Intellectual Property Office (KIPO), the contents of which are herein incorporated by reference in their entirety.

### BACKGROUND

1. Technical Field

Exemplary embodiments of the present invention relate to a gate driving circuit and a display apparatus having the gate driving circuit. More particularly, exemplary embodiments of the present invention relate to a gate driving circuit for improving the reliability of a display apparatus and a display apparatus having the gate driving circuit.

2. Discussion of Related Art

Generally, a liquid crystal display (LCD) device includes an LCD panel displaying an image using the light transmittance of liquid crystals and a backlight assembly disposed behind the LCD panel to provide light to the LCD panel.

The LCD device includes a display panel in which a plurality of pixels is formed by a plurality of gate lines and a plurality of data lines crossing the gate lines, a gate driving circuit outputting gate signals to the gate lines and a data driving circuit outputting data signals to the data lines. The gate driving circuit and the data driving circuit are generally mounted on the display panel in a semiconductor chip form.

Recently, a method whereby the gate driving circuit is integrated on a display substrate in an amorphous silicon gate form has been suggested to reduce the total size of the LCD device and to increase productivity.

When the gate driving circuit integrated on the LCD panel in an integrated circuit (IC) is driven, however, a control electrode of an output part in a period of outputting the gate signal may not maintain a gate-on voltage. Accordingly, a gate block defect, in which an output of the gate signal becomes unstable, may be generated.

### SUMMARY OF THE INVENTION

Exemplary embodiments of the present invention provide a gate driving circuit for improving the reliability of a driving operation.

Exemplary embodiments of the present invention also provide a display apparatus having the above-mentioned gate driving circuit.

According to an exemplary embodiment of the present invention, a gate driving circuit includes a shift register in which a plurality of stages is provided, wherein the stages are connected to each other one after another. The m-th stage (‘m’ is a natural number) includes a pull-up section, a pull-down section, a driving section, a holding section and a voltage maintenance section. The pull-up section outputs a high voltage of a first clock signal as a gate signal in response to a voltage of a first node converted to a first voltage by a first input signal. The pull-down section pulls down the gate signal to an off voltage in response to the first clock signal or a second clock signal having an inverted phase relative to the first clock signal. The driving section turns on and turns off the pull-up section and the pull-down section. The holding section maintains a voltage of the first node at the off voltage in response to the first clock signal. Also, the voltage maintenance section delays a voltage drop of the first node.

In an exemplary embodiment, the pull-down section comprises a first pull-down part and a second pull-down part. The first pull-down part pulls down the gate signal to the off voltage in response to the second clock signal. The second pull-down part pulls down the gate signal to the off voltage in response to the first clock signal.

In an exemplary embodiment, the driving section comprises a pull-up driving section and a pull-down driving section. The pull-down driving section turns on or turns off the pull-up section. The pull-down driving section turns off the second pull-down part and the holding section in response to a signal of the first node.

In an exemplary embodiment, the pull-up driving section comprises a first pull-up driving part and a second pull-up driving part. The first pull-up driving part outputs the first voltage to the first node in response to the first input signal. The second pull-up driving part outputs a second voltage to the first node in response to the second input signal.

In an exemplary embodiment, the first voltage is a gate-on voltage of a high level, and the second voltage is a gate-on voltage of a low level.

In an exemplary embodiment, the voltage maintenance section comprises a capacitor charging an input node of the first pull-up driving part, an input node of the second pull-up driving part and an input node of the holding section with the first voltage in response to the first input signal and a plurality of transistors discharging the first voltage charged in the capacitor.

In an exemplary embodiment, the capacitor comprises a first electrode connected to the input node of the first pull-up driving part, the input node of the second pull-up driving part and the input node of the holding section and a second electrode connected to an off voltage terminal receiving the off voltage.

In an exemplary embodiment, the transistors comprise a first transistor having a control electrode receiving the first input signal, an input electrode receiving the first voltage and an output electrode connected to the input node of the first pull-up driving part. A second transistor having a control electrode receiving the second input signal, an input electrode receiving the second voltage and an output electrode connected to the input node of the second pull-up driving part and a third transistor having a control electrode receiving the first clock signal, an input electrode receiving the off voltage and an output electrode connected to the input node of the holding section.

In an exemplary embodiment, the first voltage is a gate-on voltage of a low level and the second voltage is the gate-on voltage of a high level.

In an exemplary embodiment, the voltage maintenance section comprises a capacitor charging the first pull-up driving part, the second pull driving part, and an input node of the holding section with the second voltage in response to the second input signal and a plurality of transistors discharging the second voltage charged in the capacitor.

In an exemplary embodiment, the second input signal is a gate signal of a next subsequent stage when the first input signal is a vertical start signal, and the second input signal is the vertical start signal when the first input signal is a gate signal of a previous stage.

According to an exemplary embodiment of the present invention, a display apparatus includes a display panel, a data driving circuit and a gate driving circuit. The display panel includes a display area in which a plurality of pixels is electrically connected to gate lines and data lines crossing the gate lines and a peripheral area surrounding the display area. The data driving circuit outputs a plurality of data signals to the data lines. The gate driving circuit includes a plurality of stages connected one after another to each other, the gate driving part being formed in the peripheral area to output a plurality of gate signals to the gate lines. An m-th stage (‘m’ is a natural number) includes a pull-up section, a pull-down section, a driving section, a holding section and a voltage maintenance section. The pull-up section outputs a high voltage of a first clock signal as a gate signal in response to a voltage of a first node converted to a first voltage by a first input signal. The pull-down section pulls down the gate signal to an off voltage in response to the first clock signal or the second clock signal having an inverted phase to the first clock signal. The driving section turns on and turns off the pull-up section and the pull-down section. The holding section maintains a voltage of the first node at the off voltage in response to the first clock signal. The voltage maintenance section delays a voltage drop of the first node.

In an exemplary embodiment, the gate driving circuit comprises a first gate driving circuit having odd-numbered stages and a second gate driving circuit having even-numbered stages.

In an exemplary embodiment, the first clock signal that is input to the second gate driving circuit is delayed by a half period with respect to the first clock signal that is input to the first gate driving circuit.

According to an exemplary embodiment, the driving section comprises a pull-up driving section and a pull-down driving section. The pull-up driving section turns on and turns off the pull-up section. The pull-down driving section turns off the pull-down part and the holding section in response to a signal of the first node. The pull-up driving section comprises a first pull-up driving section and a second pull-up driving section. The first pull-up driving part outputs the first voltage to the first node in response to the first input signal. The second pull-up driving part outputs a second voltage to the first node in response to the second input signal.

In an exemplary embodiment, the second voltage is the gate-on voltage of a low level when the first voltage is a gate-on voltage of a high level, and the second voltage is the gate-on voltage of a high level when the first voltage is the gate-on voltage of a low level.

In an exemplary embodiment, the gate driving circuit outputs the gate signal from the stage of which ‘m’ is small, when the first voltage is the gate-on voltage of a high level. The gate driving circuit outputs the gate signal from the stage of which ‘m’ is large, when the second voltage is the gate-on voltage of a high level.

In an exemplary embodiment, the voltage maintenance section comprises a capacitor charging an input node of the First pull-up driving part, the second pull-up driving part and the holding section with the first voltage or the second voltage in response to the first input signal or the second input signal and a plurality of transistors discharging the first voltage or the second voltage charged in the capacitor.

According to an exemplary embodiment, the capacitor comprises a first electrode connected to the input node of the first pull-up driving part, the input node of the second pull-up driving part and the input node of the holding section and a second electrode connected an off voltage terminal receiving the off voltage.

In an exemplary embodiment, the transistors comprise a first transistor having a control electrode receiving the first input signal, an input electrode receiving the first voltage and an output electrode connected to the input node of the first pull-up driving part, a second transistor having a control electrode receiving the second input signal, an input electrode receiving the second voltage, and an output electrode connected to the input node of the second pull-up driving part and a third transistor having a control electrode receiving the first clock signal, an input electrode receiving the off voltage, and an output electrode connected to the input node of the holding section.

According to a gate driving circuit and a display apparatus having the gate driving circuit, the gate driving circuit and the display apparatus can maintain a gate-on voltage of a first node during an interval period of outputting a gate signal, even though the gate driving circuit and the display apparatus are driven at a high temperature, thereby improving the reliability of the driving operation.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is a plan view schematically illustrating a display apparatus according to an exemplary embodiment of the present invention;

FIG. 2 is a block diagram illustrating the first gate driving circuit used in the display apparatus of FIG. 1;

FIG. 3 is a block diagram illustrating the second gate driving circuit used in the display apparatus of FIG. 1;

FIG. 4 is a circuit diagram illustrating a unit stage used in the driving circuit shown in FIGS. 2 and 3;

FIG. 5 includes waveform diagrams showing input/output signals of the unit stage of FIG. 4; and

FIG. 6 is a graphical representation showing a relationship between a current and a gate-source voltage of an amorphous silicon transistor.

### DETAILED DESCRIPTION OF EXEMPLARY EMBODIMENTS

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those of ordinary skill in the art. In the drawings, the sizes and relative sizes of layers and regions may be exaggerated for clarity.

Hereinafter, exemplary embodiments of the present invention will be explained in detail with reference to the accompanying drawings.

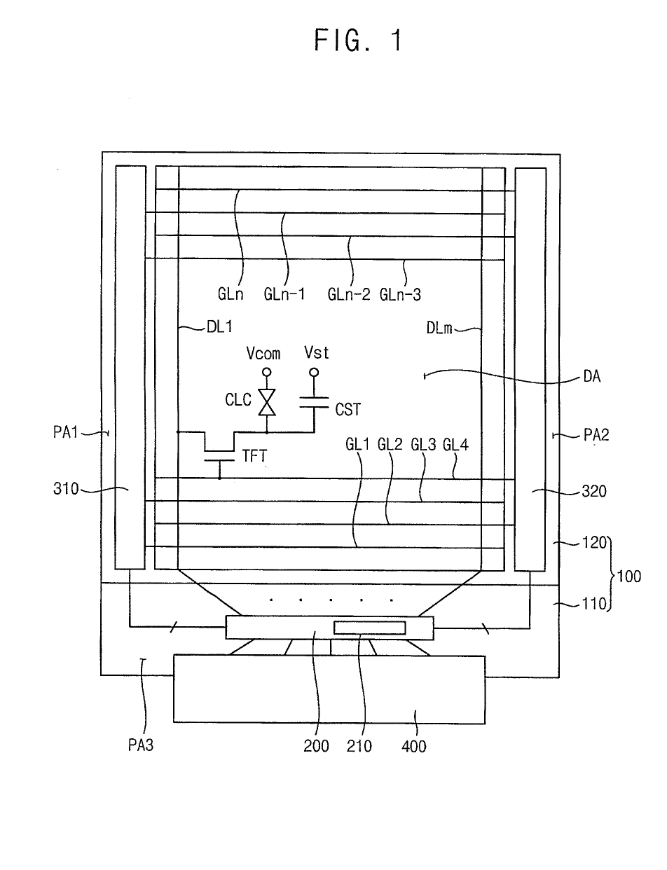

FIG. 1 is a plan view schematically illustrating a display apparatus according to an exemplary embodiment of the present invention.

Referring to FIG. 1, a display apparatus according to an exemplary embodiment of the present invention includes a display panel 100, a driving chip 200, a first gate driving circuit 310, a second gate driving circuit 320 and a printed circuit board (PCB) 400.

The display panel 100 includes a display substrate 110, an opposite substrate 120 opposite to the display substrate 110 and a liquid crystal layer (not shown) interposed between the display substrate 110 and the opposite substrate 120. The display panel 100 includes a display area DA for displaying an image and a peripheral area surrounding the display area DA.

A plurality of gate lines GL1 to GLn and a plurality of data lines DL1 to DLm crossing the gate lines GL1 to GLn are formed on the display panel 100 (‘n’ and ‘m’ are natural numbers). A plurality of pixels are electrically connected to the gate lines GL1 to GLn and the data lines DL1 to DLm. Each of the pixels includes a transistor TFT, a liquid crystal capacitor CLC and a storage capacitor CST.

The peripheral area includes a first peripheral area PA1, a second peripheral area PA2, and a third peripheral area PA3. The first peripheral area PA1 is positioned at a first end portion of the gate lines GL1 to GLn, the second peripheral area PA2 is positioned at a second end portion of the gate lines GL1 to GLn, and the third peripheral area PA3 is positioned at a first end portion of the data lines DL1 to DLm.

The PCB 400 may be attached to one side of the third peripheral area PA3. The PCB 400 electrically connects the driving chip 200 to an external device (not shown) to transmit an image signal and a control signal received from the external device to the driving chip 200. The PCB 400 may be a flexible printed circuit board (FPCB).

The driving chip 200 is mounted on the third peripheral area PA3. The driving chip 200 provides a first gate control signal and a second gate control signal to the first and second gate driving circuits 310 and 320, respectively, and provides a data voltage to the data lines DL1 to DLm. The driving chip 200 includes a data driving circuit 210. The data driving circuit 210 converts the image signal received from the external device into an analog data voltage to output the analog data voltage to the data lines DL1 to DLm.

The first gate driving circuit 310 is integrated on the first peripheral area PA1. The first gate driving circuit 310 is electrically connected to odd-numbered gate lines GL1, GL3, . . . , and GLn−1 of the gate lines GL1 to GLn to sequentially output gate signals to the odd-numbered gate lines GL1, GL3, . . . , and GLn−1. Here, n is an even number.

The second gate driving circuit 320 is integrated on the second peripheral area PA2. The second gate driving circuit 320 is electrically connected to even-numbered gate lines GL2, GL4, . . . , and GLn of the gate lines GL1 to GLn to sequentially output the gate signals to the even-numbered gate lines GL2, GL4, . . . , and GLn.

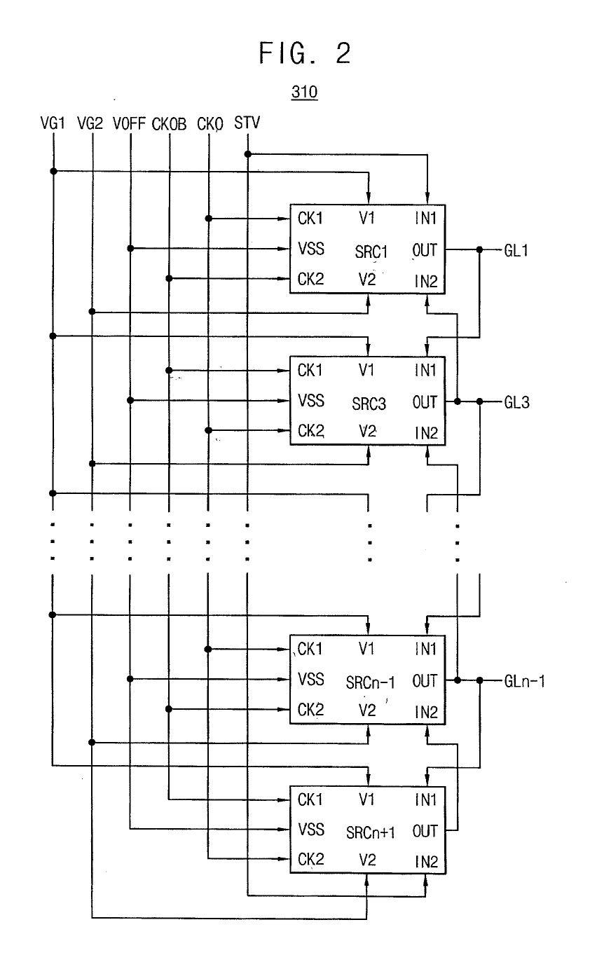

FIG. 2 is a block diagram illustrating the first gate driving circuit 310 of FIG. 1.

Referring to FIGS. 1 and 2, the first gate driving circuit 310 includes odd-numbered stages SRC1, SRC3, . . . , and SRCn−1 sequentially connected to each other.

The first gate driving circuit 310 includes the odd-numbered stages SRC1, SRC3, . . . , and SRCn−1 outputting the odd-numbered gate signals and a dummy stage SRCn+1. The first gate driving circuit 310 may further include an (n+3)-th stage SRCn+3 (not shown) or more stages, to minimize noise which is included in an output signal of the odd-numbered stages SRC1, SRC3, . . . , and SRCn−1 during a porch period before the start of the signals of each of the stages is input.

Each of the odd-numbered stages SRC1, SRC3, . . . , and SRCn−1 includes a first clock terminal CK1, a second clock terminal CK2, a first input terminal IN1, a second input terminal IN2, an off voltage terminal VSS, a first voltage terminal V1, a second voltage terminal V2, and an output terminal OUT.

A first clock signal CKO and a second clock signal CKOB having an opposite phase relative to the first clock signal CKO are provided to the first and second clock terminals CK1 and CK2, respectively. For example, the first clock signal CKO is provided to the first clock terminal CK1 of the stages SRC1, SRC5 (not shown), . . . , and SRCn−1, and the second clock signal CKOB is provided to the second clock terminal of the stages SRC1, SRC5, (not shown) . . . , and SRCn−1. The second clock signal CKOB is provided to the first clock terminal CK1 of the stages SRC3, SRC7 (not shown), . . . , and SRCn−3 (not shown), and the first clock signal CKO is provided to the second clock terminal CK2 of the stages SRC3, SRC7, (not shown) . . . , and SRCn−3 (not shown). The first clock signal CKO and the second clock signal CKOB having the opposite phase relative to the first clock signal CKO are applied to the first and second clock terminals CK1 and CK2 of each of the stages SRC1, SRC3, SRC5, SRC7 . . . , and SRCn−3 and SRCn−1 to sequentially operate each of the stages SRC1, SRC3, SRC5, SRC7 . . . , and SRCn−3 and SRCn−1. For example, the first clock signal CKO may be inverted by 2H (‘H’ is a horizontal period) with respect to the second clock signal CKOB.

A vertical start signal STV, or a gate signal of a previous stage, is provided to the first input terminal IN1. That is, the vertical start signal STV is provided to the first input terminal IN1 of the first stage SRC1 that is the first stage of the first gate driving circuit 310, and each of the gate signals of the previous stages is respectively provided to each of the first input terminals IN1 of a third stage SRC3 to an (n+1)-th stage SRCn+1.

A gate signal of a next successive stage, or the vertical start signal STV is provided to the second input terminal IN2. Each of the gate signals of the next successive stages SRC3 to SRCn+1 is provided to each of the second input terminals IN2 of the first stage SRC1 to the (n−1)-th stage SRCn−1, respectively, and the vertical start signal STV is provided to the second input terminal IN2 of the (n+1)-th stage SRCn+1.

An off voltage VOFF is provided to the off voltage terminal VSS.

A first voltage VG1 is provided to the first voltage terminal V1, and a second voltage VG2 is provided to the second voltage terminal V2. The first and second voltages VG1 and VG2 are gate-on voltages. A high voltage level and a low voltage level may alternate as the first voltage VG1 and the second voltage VG2, respectively. That is, the second voltage VG2 is at a low level when the first voltage VG1 is at a high level, and the second voltage VG2 is at a high level when the first voltage VG1 is at a low level. For example, the high voltage level may be about 15 V, and the low voltage level may be about −10 V.

The output terminal OUT outputs the gate signals to the gate lines electrically connected thereto. The gate signals of the stages SRC1, SRC5, (not shown) . . . , and SRCn−1 that are output from the output terminal OUT of the odd-numbered stages SRC1, SRC3, . . . , and SRCn+1 are output during a high level interval of the first clock signal CKO. The gate signals of the stages SRC3, SRC7, (not shown) . . . , and SRCn−3 output from the output terminal OUT of the odd-numbered stages SRC1, SRC3, . . . , and SRCn+1 are output during a high level interval of the second clock signal CKOB. Accordingly, the odd-numbered stage SRC1, SRC3, . . . , and SRCn+1 sequentially output the odd-numbered gate signals G1, G3, . . . , and Gn−1, respectively.

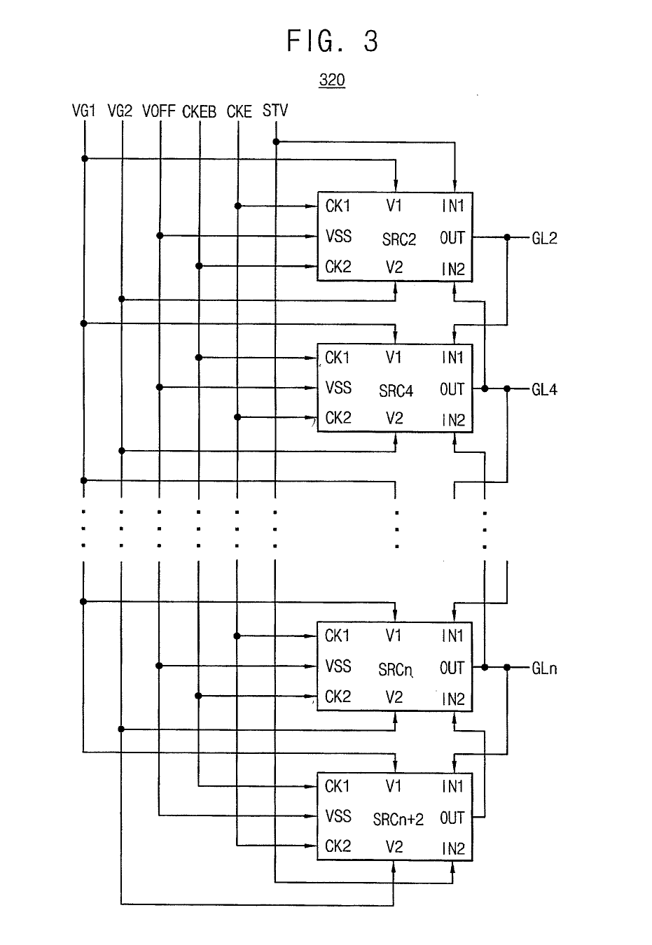

FIG. 3 is a block diagram illustrating the second gate driving circuit 320 of FIG. 2.

Referring to FIGS. 1 and 3, the second gate driving circuit 320 includes the even-numbered stages SRC2, SRC4, . . . , and SRCn sequentially connected to each other.

The second gate driving circuit 320 includes the even-numbered stages SRC2, SRC4, . . . , and SRCn outputting the even-numbered gate signals and a dummy stage SRCn+2. The second gate driving circuit 320 may further include an (n+4)-th stage SRCn+4 (not shown) or more stages, to minimize a noise which may be included in an output of the even-numbered stages SRC2, SRC4, . . . , and SRCn during a porch period of the input signals.

Each of the even-numbered stages SRC2, SRC4, . . . , and SRCn includes a first clock terminal CK1, a second clock terminal CK2, a first input terminal IN1, a second input terminal IN2, an off voltage terminal VSS, a first voltage terminal V1, a second voltage terminal V2, and an output terminal OUT.

A third clock signal CKE and a fourth clock signal CKEB having an opposite phase relative to the third clock signal CKE are provided to the first and second clock terminals CK1 and CK2, respectively. For example, the third clock signal CKE is provided to the first clock terminal CK1 of the stages SRC2, SRC6 (not shown), . . . , and SRCn and the fourth clock signal CKEB is provided to the second clock terminal CK2 of the stages SRC2, SRC6, (not shown) . . . , and SRCn. The fourth clock signal CKEB is provided to the first clock terminal CK1 of the stages SRC4, SRC8 (not shown), . . . , and SRCn−2 (not shown) and the third clock signal CKE is provided to the second clock terminal CK2 of the stages SRC4, SRC8, (not shown) . . . , and SRCn−2 (not shown). The third clock signal CKE is a signal delayed by a half period with respect to the first clock signal CKO. For example, the third clock signal CKE may be inverted by 2H (‘H’ is a horizontal period) with respect to the fourth clock signal CKEB having the opposite phase relative to the first clock signal CKO. The third clock signal CKE may be a signal delayed by 1H with respect to the first clock signal CKO.

A vertical start signal STV, or a gate signal of a previous stage, is provided to the first input terminal IN1. That is, the vertical start signal STV is provided to the first input terminal IN1 of a second stage SRC2 that is a first stage of the second gate driving circuit 320, and each of the gate signals of the previous stages is provided to each of the first input terminals IN1 of a fourth stage SRC4 to an (n+2)-th stage SRCn+2.

A gate signal of a next successive stage or the vertical start signal STV, is provided to the second input terminal IN2. Each of the gate signals of the next successive stages SRC4 to SRCn+2 is provided to each of the second input terminals IN2 of the second stage SRC2 to the n-th stage SRCn, respectively, and the vertical start signal STV is provided to the second input terminal IN2 of the (n+2)-th stage SRCn+2.

An off voltage VOFF is provided to the off voltage terminal VSS.

A first voltage VG1 is provided to the first voltage terminal V1, and a second voltage VG2 is provided to the second voltage terminal V2. The first and second voltages VG1 and VG2 are gate-on voltages. A high voltage level and a low voltage level may be alternately input as each of the first voltage VG1 and the second voltage VG2, respectively. That is, the second voltage VG2 is at a low level when the first voltage VG1 is at a high level, and the second voltage VG2 is at a high level when the first voltage VG1 is at a low level. For example, the high voltage level may be about 15 V, and the low voltage level may be about −10 V.

The output terminal OUT outputs the gate signals to the gate lines electrically connected thereto. The gate signals of the stages SRC2, SRC4, . . . , and SRCn that are output from the output terminal OUT1 of the even-numbered stages SRC2, SRC4, . . . , and SRCn are output during a high level interval of the third clock signal CKE. The gate signals of the stages SRC4, SRC8, (not shown) . . . , and SRCn−2 that are output from the output terminal OUT of the even-numbered stages SRC2, SRC4, . . . , and SRCn are output during a high level interval of the fourth clock signal CKEB. Accordingly, the even-numbered stages SRC2, SRC4, . . . , and SRCn sequentially output the even-numbered gate signals G2, G4, . . . , and Gn, respectively.

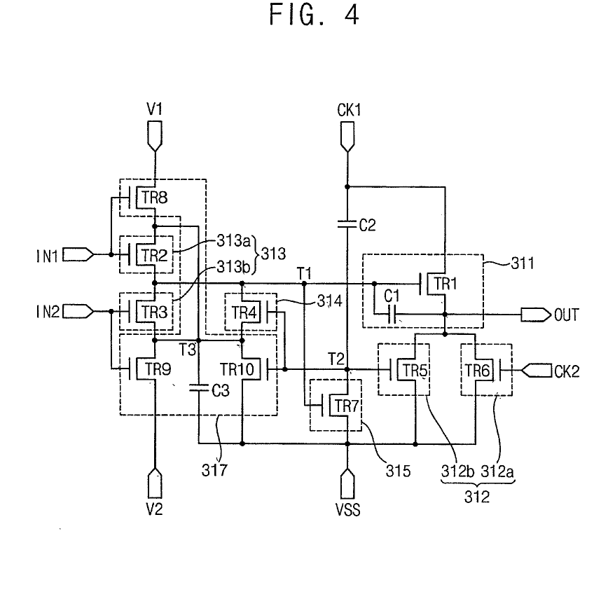

FIG. 4 is a circuit diagram illustrating a unit stage used in the driving stages 310 and 320 shown in FIGS. 2 and 3, respectively.

Hereinafter, for convenience of description, it will be explained as an example that the first clock signal CKO and the second clock signal CKOB are provided to each of the first clock terminal CK1 and the second clock terminal CK2 of the stages of the first gate driving circuit 310 to drive the stages of the first gate driving circuit 310. The first clock signal CKO and the second clock signal CKOB are signals having opposite phases relative to each other.

Referring to FIGS. 2 and 4, each driving stage includes a pull-up section 311, a pull-down section 312, a pull-up driving section 313, a holding section 314, and a voltage maintenance section 317.

The pull-up section 311 outputs the period of the high level of the signal fed to the first clock terminal CK1, that is, the first clock signal CKO provided to the first clock terminal CK1, to the output terminal OUT to pull up the gate signal.

For example, the pull-up section 311 includes a first transistor TR1 having an input electrode connected to the first clock terminal CK1 and an output electrode connected to the output terminal OUT. The pull-up section 311 may further include a first capacitor C1 formed between a control electrode and the output electrode of the first transistor TR1. The first capacitor C1 charges the first voltage VG1 provided from the first voltage terminal V1 to be applied to the control electrode of the first transistor TR1, and turns on the first transistor TR1. The first capacitor C1 may be defined by an overlapping area of the control electrode and the output electrode of the first transistor TR1.

The pull-down section 312 includes a first pull-down part 312a and a second pull-down part 312b. The first pull-down part 312a converts the gate signal that is output to the output terminal OUT to the off voltage VOFF, that is, to a low value, in response to the second clock signal CKOB, which is a signal at the second clock terminal CK2, to pull down the gate signal. The second pull-down part 31 2b maintains the gate signals that are output to the output terminal OUT at the off voltage VOFF, in response to the first clock signal CKO, which is a signal at the first clock terminal CK1, to pull down the gate signal. Here, the first clock signal CKO turning on the second pull-down part 312b is a signal charged in a second capacitor C2, which will be explained hereinbelow.

For example, the first pull-down part 312a includes a sixth transistor TR6 having an input electrode connected to the off voltage terminal VSS, a control electrode connected to the second clock terminal CK2 to receive the second clock signal CKOB, and an output electrode connected to the output terminal OUT. The second pull-down part 312b includes a fifth transistor TR5 having an input electrode connected to the off voltage terminal VSS to receive the off voltage VOFF, a control electrode connected to the second capacitor C2 and an output electrode connected to the output terminal OUT.

The pull-up driving section 313 turns on the pull-up section 311 in response to a high value of the output signal of the previous stage, which is a signal at the first input terminal IN1, and turns off the pull-up section 311 in response to the high value of the output signal of the next stage, which is a signal of the second input terminal IN2.

For example, the pull-up driving section 313 includes a first pull-up driving part 313a and a second pull-up driving part 313b. The first pull-up driving part 313a includes a second transistor TR2 having an input electrode connected to the voltage maintenance section 317 to receive the first voltage VG1, a control electrode connected to the first input terminal IN1 and an output terminal connected to the control electrode of the first transistor TR1 of the pull-up section 311 to form a first node F1. In this exemplary embodiment, the control electrode of the first transistor TR1 serves to switch on/off the pull-up section 311. The second pull-up driving part 313b includes a third transistor TR3 having an input electrode connected to the voltage maintenance 317 to receive the second voltage VG2, an output electrode connected to the control electrode of the first transistor TR1 to form the first node T1, and a control electrode connected to the second input terminal IN2.

When the second transistor TR2 of the pull-up driving section 313 is turned on in response to the high value of the output signal of the previous stage, the first voltage VG1 is applied to the first node T1 to be charged in the first capacitor C1. A charge higher than a threshold voltage of the first transistor TR1 is charged in the first capacitor C1. Next, while the low value of the first clock signal CKO is converted to the high value, the first transistor TR1 is bootstrapped to output the high value of the first clock signal CKO to the output terminal OUT.

Thereafter, when the third transistor TR3 is turned on in response to the high value of the output signal of the next successive stage, the charge in the first capacitor C1 is discharged to the off voltage VOFF of the off voltage terminal VSS. Due to the discharge of the first capacitor C1, the high value of the first node T1 is converted to the low value, so that the first transistor TR1 is turned off to stop the output of the first clock signal CKO.

When the sixth transistor TR6 of the pull-down section 312 is turned on in response to the turn-off of the first transistor TR1 and the high value of the second clock signal CKOB, the gate signal that is output through the output terminal OUT is converted to the off voltage VOFF. In addition, the fifth transistor TR5 of the pull-down section 312 is turned on in response to the high value of the first clock signal CKO charged in the second capacitor C2 and a signal that is output to the output terminal OUT is continuously maintained at the low value. That is, the sixth transistor TR6 and the fifth transistor TR5 are alternately turned on to pull down the gate signal, which is output to the output terminal OUT, to the low value.

The holding section 314 maintains the first node T1 at the off voltage VOFF, to prevent a ripple at the first node T1 that might be produced by a coupling of the first clock signal CKO.

For example, the holding section 314 includes a fourth transistor TR4 having an input electrode connected to the voltage maintenance section 317 to receive the off voltage VOFF, a control electrode connected to the second capacitor C2 to receive the first clock signal CKO, and an output electrode connected to the first node T1. After the gate signal is converted to the low value by the pull-down section 312, the holding section 314 maintains the first node T1 at the low value to turn off the pull-up section 311 and prevents ripple from being generated in the first node T1 due to the coupling by the first clock signal CKO. That is, when the fourth transistor TR4 is turned on in response to the high value of the first clock signal CKO charged in the second capacitor C2, the holding section 314 applies the off voltage VOFF to the first node T1 to maintain the first node T1 at the low voltage.

The voltage maintenance section 317 includes a third capacitor C3, an eighth transistor TR8, a ninth transistor TR9, and a tenth transistor TR10. The voltage maintenance section 317 blocks a leakage current of the pull-up driving section 313 and the holding section 314 during the period of outputting the gate signal, to thereby delay a voltage drop of the first node T1. Accordingly, the voltage maintenance section 317 maintains a voltage of the first node T1 at a level higher than the first voltage VG1.

A first electrode of the third capacitor C3 is connected to the input electrode of the second transistor TR2, the input electrode of the third transistor TR3, and the input electrode of the fourth transistor TR4 to form a third node T3, and the second electrode of the third capacitor C3 is connected to the off voltage terminal VSS.

The eighth transistor TR8 includes an input electrode connected to the first voltage terminal V1 to receive the first voltage VG1, a control electrode connected to the first input terminal IN1, and an output electrode connected to the input electrode of the second transistor TR2 to be connected to the third node T3. The ninth transistor TR9 includes an input electrode connected to the second voltage terminal V2 to receive the second voltage VG2, a control electrode connected to the second input terminal IN2, and an output electrode connected to the input electrode of the third transistor TR3 to be connected to the third node T3. The tenth transistor TR10 includes an input electrode connected to the off voltage terminal VSS to receive the off voltage VOFF, a control electrode connected to the second capacitor C2 to receive the first clock signal CKO, and an output electrode connected to the input electrode of the fourth transistor TR4 to be connected to the third node T3.

For example, while the second transistor TR2 of the pull-up driving section 313 is turned on in response to the high value of a signal of the first input terminal IN1 and the first voltage VG1 is applied to the first node T1 to be charged in the first capacitor C1, the eighth transistor TR8 is turned on and the first voltage VG1 is applied to the third node T3 to be charged in the third capacitor C3.

Thereafter, while the first transistor TR1 outputs the high value of the first clock signal CKO to the output terminal OUT, the third node T3 is maintained at the first voltage VG1. When the high value of the next gate signal is inputted at the terminal IN2 to the control electrode of the ninth transistor TR9 and the high value of the first clock signal CKO is inputted at terminal CK1 to the control electrode of the tenth transistor TR10, the ninth transistor TR9 and the tenth transistor TR10 discharge the first voltage VG1 charged in the third capacitor C3 at the third node T3. The ninth transistor TR9 and the tenth transistor TR10 delay the voltage of the first node T1 being discharged to the off voltage OFF during the period of outputting the gate signal, to maintain the gate-source voltages VGS of the third transistor TR3 and the fourth transistor TR4 at a negative voltage.

For example, the gate signal of the next successive stage is inputted to the control electrode of the ninth transistor TR9 and the second node T2, which is the control electrode of the tenth transistor TR10, is maintained at the low level during the period of outputting the gate signal. Accordingly, the first voltage VG1 of the third node T3 is maintained until the ninth transistor TR9 and the tenth transistor TR10 discharge the charge in the third capacitor C3. Thus, the gate-source voltages VGS of the third transistor TR3 and the fourth transistor TR4 are maintained at lower than 0 V, thereby reducing a leakage current and delaying a voltage drop of the first node T1.

When the gate-source voltages VGS of the third transistor TR3 and the fourth transistor TR4 are maintained at lower than −1 V, the leakage currents of the third transistor TR3 and the fourth transistor TR4 may be reduced by more than 1 order (here, 1 order means 1*10−1[A]). When the gate-source voltage VGS is 0 V in a case that the gate driving circuit is operated at a high temperature, the leakage current is increased by 1 order to 2 orders. Accordingly, the gate driving circuit according to an exemplary embodiment of the present invention compensates the increase rate of the leakage current, thereby improving the reliability of the driving operation.

Accordingly, the voltage maintenance section 317 delays a voltage drop of the first node T1 connected to the control electrode of the first transistor TR1, to prevent the voltage of the first node T1 from being dropped to lower than the first voltage VG1 during a gate-on-signal period. Because the first node T1 maintains the gate-on voltage during the period of outputting the gate signal, the first transistor TR1 may output a stable gate signal.

The voltage maintenance section 317, when the first voltage VG1 is the gate-on voltage of the high level and the second voltage VG2 is the gate-on voltage of the low level, has been explained only as an example. In a two-way gate driving circuit, however, the first voltage VG1 may be the gate-on voltage of the low level and the second voltage VG2 may be the gate-on voltage of the high level. When the second voltage VG2 is the gate-on voltage of the high level, the third transistor TR3 is turned on in response to the high value of the signal at the second input terminal IN2, and the second voltage VG2 is applied to the first node T1 to be charged in the first capacitor C1. Likewise, when the second voltage VG2 is the gate-on voltage of the high level, the ninth transistor TR9 is turned on in response to the high value of the signal of the second input terminal IN2, and the second voltage VG2 is applied to the third node T3 to be charged in the third capacitor C3.

Each of the stages may further include a pull-down controlling section 315. The pull-down controlling section 315 turns off the second pull-down part 312b and the holding section 314 in response to the signal of the first node T1.

For example, the pull-down controlling section 315 includes a seventh transistor TR7 having an input electrode connected to the off voltage terminal VSS to receive the off voltage VOFF, an output electrode connected to the second node T2 and a control electrode connected to the first node T1. When the high value of the first clock signal CKO is applied to the second node T2 through the switching capacitor C2 and the signal of the first node T1 is the high value, the seventh transistor TR7 of the pull-down controlling section 315 is turned on to convert the high value of the second node T2 to the low value. Accordingly, in the period in which the first node T1 has the high value, so that the pull-up section 310 is turned on, even though the first clock signal CKO has the high value, the holding section 314 is turned off.

The switching capacitor C2 includes a first electrode and a second electrode. The first electrode is connected to the first clock terminal CK1 and the second electrode connected to the control electrodes of the fifth transistor TR5 and the tenth transistor TR10 and the output electrode of the seventh transistor TR7 to form the second node T2. The switching capacitor C2 receives the first clock signal CKO and stores the voltage of the first clock signal CKO. The switching capacitor C2 applies a stored first clock signal CKO to the second node T2 to turn on/off the fifth transistor TR5 and the tenth transistor TR10.

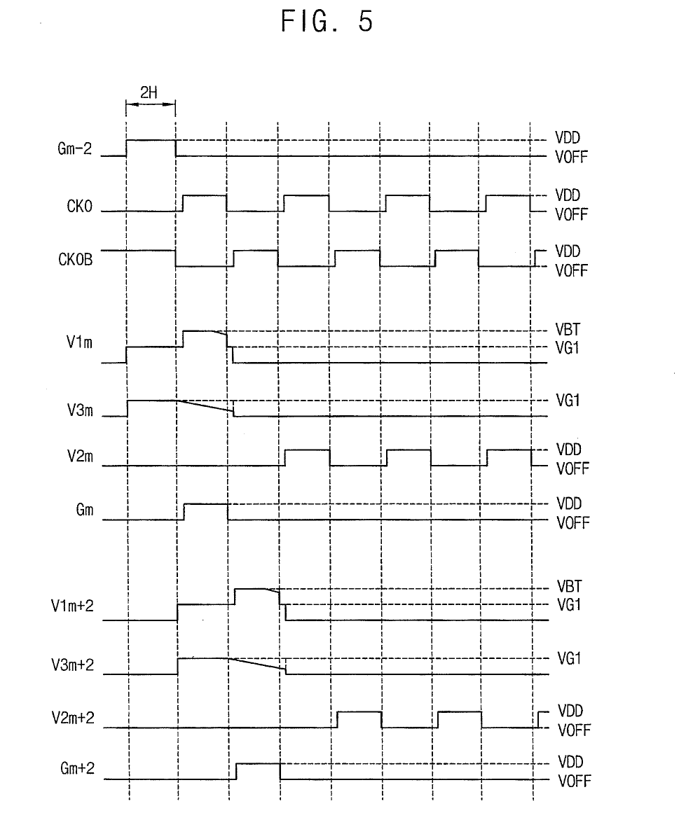

FIG. 5 represents waveform diagrams showing input/output signals of the unit stage of FIG. 4.

The waveform diagrams of FIG. 5 show the gate signal Gm−2, the first clock signal CKO and the second clock signal CKOB as input signals of the m-th stage SRCm, a voltage V1m of the first node T1, a voltage V3m of the third node T3, a voltage V2m of the second node T2 of the m-th stage SRCm, and the gate signal Gm, that is, an output signal of the m-th stage SRCm. Moreover, the waveform diagrams show a voltage V1m+2 of the first node T1, a voltage V2m+2 of the second node T2 of an (m+2)−t stage SRCm+2, that is, the next successive stage of the m-th stage SRCm, and the gate signal Gm+2, that is, the output signal of the (m+2)-th stage SRCm+2.

Referring to FIGS. 2, 4, and 5, the gate signal Gm−2, the first clock signal CKO and the second clock signal CKOB are inputted to the m-th stage SRCm. The gate signal Gm−2 is the vertical start signal STV, or the gate signal of the previous stage SRC−2, that is input to the first input terminal IN1 of the m-th stage SRCm, the first clock signal CKO is a clock signal that is input to the first clock terminal CK1, and the second clock signal CKOB is a clock signal that is input to the second clock terminal CK2.

The vertical start signal STV, or the gate signal Gm−2 of the previous stage SRCm−2, that is input to the first input terminal IN1 may have the high voltage during a 2H period (‘H’ is a horizontal period), and be converted to the off voltage (the low voltage) VOFF. For example, the 1H may be a period of 67 μs.

The gate signal Gm−2 is converted into the off voltage, and then the first clock signal CKO is converted into the voltage VDD of the high level. In the first clock signal CKO, the high voltage VDD and the off voltage (the low voltage) VOFF may be alternately converted roughly every 2H. The second clock signal CKOB may have the opposite phase to that of the first clock signal CKO. The waveform diagrams of the first clock signal CKO and the second clock signal CKOB described in FIG. 5 show real waveform diagrams of effective clock signals in the m-th stage SRCm, considering a rising time of the clock signal.

When the vertical start signal STV, or the gate signal Gm−2 of the previous stage SRCm−2, is inputted to the first input terminal IN1 of the m-th stage SRCm, the first node T1 and the third node T3 are charged with the first voltage VG1. Thereafter, when the first clock signal CKO is inputted to the first clock terminal CK1, the voltage V1m of the first node T1 is boosted from the first voltage VG1 to a boosting voltage VBT, so that the period of a high level of the first clock signal CKO is outputted with the gate signal Gm in response to the boosting.

During the period of outputting the gate signal Gm, the voltage V3m of the third node T3 maintains the first voltage VG1 to maintain the gate-source voltages VGS of the third transistor TR3 and the fourth transistor TR4 to be lower than about 0 V to reduce the leakage current. Accordingly, during the period of outputting the gate signal Gm, the voltage V1m of the first node T1 that is inputted to the control electrode of the first transistor TR1 is maintained higher than the first voltage VG1, so that the first transistor TR1 outputs the stable gate signal Gm. The voltage V3m of the third node T3 and the voltage V1m of the first node T1 shown in FIG. 5 show a theoretically maintained voltage with a dotted line and a lowered voltage with a solid line. During the period of outputting the gate signal, the voltage V2m of the second node T2 that is inputted to the control electrode of the tenth transistor TR10 maintains the low voltage. Thereafter, the voltage V2m of the second node T2 is synchronized to the high voltage VDD of the first clock signal CKO, so that the high voltage VDD and the off voltage VOFF may be alternately converted every 2H period (‘H’ is a horizontal period).

Likewise, when the gate signal Gm of the previous stage SRCm is inputted to the first input terminal IN1 of the (m+2)-th stage SRCm+2, that is, the next successive stage of the m-th stage SRCm, the first node T1 and the third node T3 are charged with the first voltage VG1. When the second clock signal CKOB is inputted to the second clock terminal CK2, the period of a high level of the second clock signal CKOB is outputted as the gate signal Gm+2. During the period of outputting the gate signal Gm+2, the voltage of the third node T3 maintains the first voltage VG1, and the gate-source voltages VGS of the third transistor TR3 and the fourth transistor TR4 are maintained to be lower than about 0 V, to thereby reduce the leakage current. Accordingly, during the period of outputting the gate signal Gm+2, the voltage V1m+2 of the first node T1, that is, the control electrode of the first transistor TR1 is maintained higher than the first voltage VG1, so that the first transistor TR1 may output the stable gate signal Gm+2.

When the voltage maintenance section 317 of FIG. 4 is omitted, during the period of outputting the gate signal, the voltage of the first node T1 drops to lower than the first voltage VG1 by the leakage currents of the third transistor TR3 and the fourth transistor TR4, so that the gate signal Gm may become unstable. The voltage drop of the first node T1 is generated because an amount of the leakage current of the transistor is large when the gate-source voltage VGS is 0 V in the case that the amorphous silicon transistor circuit is operated at a high temperature. For example, during the period of outputting the gate signal Gm, even though the gate-source voltage VGS is 0 V, the leakage currents are generated in the third transistor TR3 and the fourth transistor TR4 of the gate driving circuit. Accordingly, because the voltage of the first node T1 may not be maintained higher than the first voltage VG1, that is, the gate-on voltage of the first transistor TR1, the abnormal output of the gate signal is generated.

The exemplary embodiment of the present invention including the voltage maintenance section 317 delays the voltage drop of the first node T1 during the period of outputting the gate signal Gm, so that the output of the gate signal may be stable in a high temperature operation. For example, as described in FIG. 5, during the interval period of outputting the gate signal Gm, the first node T1 may be maintained higher than the gate-on voltage. Alternatively, when the voltage maintenance section 317 shown in FIG. 4 is omitted, during the period of outputting the gate signal Gm, the voltage of the first node T1 is dropped to lower than the gate-on voltage due to the leakage current, so that the gate signal Gm can become unstable.

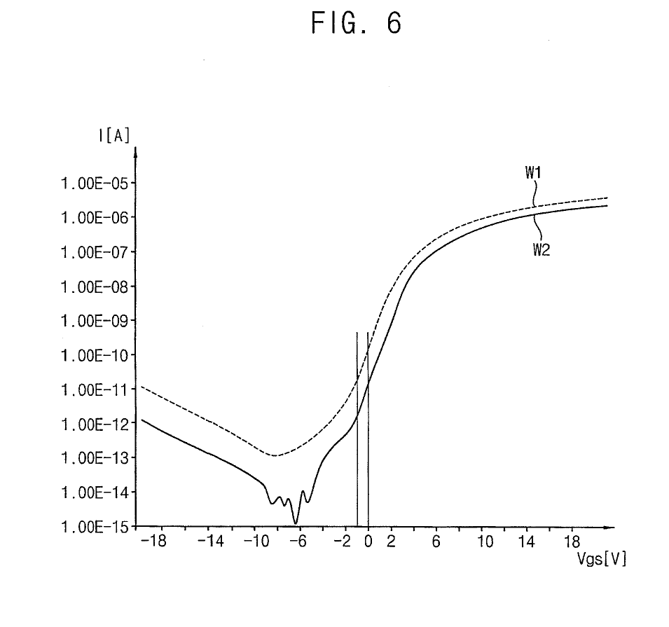

FIG. 6 is a graphical representation showing a relationship between a current and a gate-source voltage of an amorphous silicon transistor.

In FIG. 6, a second waveform W2 is a plot of a current measured in a initial driving of the amorphous silicon transistor and a first waveform W1 is a plot of a current measured at a high operating temperature after the amorphous silicon transistor has been driven for a long time.

Referring to FIG. 6, the x-axis represents the gate-source voltage VGS of the amorphous silicon transistor, and the y-axis represents a current according to the gate-source voltage VGS of the amorphous silicon transistor. As shown by the second waveform W2, the amorphous silicon transistor has a comparatively large leakage current even though the gate-source voltage VGS is about 0 V. For example, when the gate driving circuit is operated at a high temperature, the leakage current may be increased, as shown by the first waveform W1 according to the characteristic of the amorphous silicon transistor. As shown in FIG. 6, it may be confirmed that the leakage current of when the gate-source voltage VGS is about −1 V is smaller by about 1 order than the leakage current when the gate-source voltage VGS is about 0 V.

Accordingly, an exemplary embodiment of the present invention maintains the gate-source voltages VGS the third transistor TR3 and the fourth transistor TR4 to be lower than about 0 V during the period of outputting the gate signal by the voltage maintenance section 317, thereby reducing the leakage current by more than 1 order and delaying the voltage drop of the first node T1 by the reduction of the leakage current.

For example, during the period of outputting the gate signal, the gate signal of the next successive stage inputted to the control electrode of the ninth transistor TR9 and the voltage of the second node T2, that is, the voltage of the control electrode of the tenth transistor TR10, are maintained with the low level. Accordingly, until the ninth transistor TR9 and the tenth transistor TR10 of the voltage maintenance section 317 discharge the charge in the third capacitor C3, the gate-on voltage of the third node T3 is maintained. Thus, the voltage maintenance section 317 maintains the gate-source voltages VGS of the third transistor TR3 and the fourth transistor TR4 to be lower than about 0 V to reduce the leakage current and to delay the voltage drop of the first node T1, thereby solving the problem of distortion of the gate signal.

As described above, according to an exemplary embodiment of the present invention, leakage currents of a third transistor and a fourth transistor are reduced during a period of outputting a gate signal, thereby ensuring the reliability of a gate driving circuit, including a voltage maintenance section delaying a voltage drop of a first node, in a high-temperature operation.

The foregoing is illustrative of an exemplary embodiment of the present invention and is not to be construed as limiting thereof. Although exemplary embodiments of the present invention have been described, those of ordinary skill in the art will readily appreciate that many modifications are possible in the exemplary embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific exemplary embodiments disclosed, and that modifications to the disclosed exemplary embodiments, as well as other example embodiments, are intended to be included within the scope of the appended claims. The present invention is defined by the following claims, with equivalents of the claims to be included therein.

What is claimed is:

1. A gate driving circuit including a shift register having a plurality of stages, in which the stages are connected to each other one after another,
an m-th stage, where ‘m’ is a natural number, comprising:
a pull-up section outputting a high voltage of a first clock signal as a gate signal in response to a voltage of a first node converted to a first voltage by a first input signal;
a pull-down section pulling down the gate signal to an off voltage in response to one of the first clock signal and a second clock signal having an inverted phase relative to the first clock signal;
a driving section turning on and turning off the pull-up section and the pull-down section;
a holding section maintaining a voltage of the first node at the off voltage in response to the first clock signal; and
a voltage maintenance section delaying a voltage drop of the first node.

2. The gate driving circuit of claim 1, wherein the pull-down section comprises:
a first pull-down part pulling down the gate signal to the off voltage in response to the second clock signal; and
a second pull-down part pulling down the gate signal to the off voltage in response to the first clock signal.

3. The gate driving circuit of claim 2, wherein the driving section comprises:
a pull-up driving section turning on or turning off the pull-up section; and
a pull-down driving section turning off the second pull-down part and the holding section in response to a signal of the first node.

4. The gate driving circuit of claim 3, wherein the pull-up driving section comprises:
a first pull-up driving part outputting the first voltage to the first node in response to the first input signal; and
a second pull-up driving part outputting a second voltage to the first node in response to the second input signal.

5. The gate driving circuit of claim 4, wherein the first voltage is a gate-on voltage of a high level, and the second voltage is a gate-on voltage of a low level.

6. The gate driving circuit of claim 5, wherein the voltage maintenance section comprises:
a capacitor charging an input node of the first pull-up driving part, an input node of the second pull-up driving part, and an input node of the holding section with the first voltage in response to the first input signal; and
a plurality of transistors discharging the first voltage charged in the capacitor.

7. The gate driving circuit of claim 6, wherein the capacitor comprises:
a first electrode connected to the input node of the first pull-up driving part, the input node of the second pull-up driving part, and the input node of the holding section; and
a second electrode connected to an off voltage terminal receiving the off voltage.

8. The gate driving circuit of claim 7, wherein the plurality of transistors comprise:
a first transistor comprising a control electrode receiving the first input signal, an input electrode receiving the first voltage, and an output electrode connected to the input node of the first pull-up driving part;
a second transistor comprising a control electrode receiving the second input signal, an input electrode receiving the second voltage, and an output electrode connected to the input node of the second pull-up driving part; and
a third transistor comprising a control electrode receiving the first clock signal, an input electrode receiving the off voltage, and an output electrode connected to the input node of the holding section.

9. The gate driving circuit of claim 4, wherein the first voltage is a gate-on voltage of a low level, and the second voltage is the gate-on voltage of a high level.

10. The gate driving circuit of claim 9, wherein the voltage maintenance section comprises:
a capacitor charging the first pull-up driving part, the second pull driving part, and an input node of the holding section with the second voltage in response to the second input signal; and
a plurality of transistors discharging the second voltage charged in the capacitor.

11. The gate driving circuit of claim 1, wherein the second input signal is a gate signal of a next successive stage when the first input signal is a vertical start signal, and
the second input signal is the vertical start signal when the first input signal is a gate signal of a previous stage.

12. A display apparatus comprising:
a display panel having a display area with a plurality of pixels electrically connected to gate lines and data lines crossing the gate lines, and a peripheral area surrounding the display area;
a data driving circuit outputting a plurality of data signals to the data lines; and
a gate driving circuit having a plurality of stages connected to each other one after another, the gate driving circuit being formed in the peripheral area to output a plurality of gate signals to the gate lines,
an m-th stage, where ‘m’ is a natural number, comprising:
a pull-up section outputting a high voltage of a first clock signal as a gate signal in response to a voltage of a first node converted to a first voltage by a first input signal;
a pull-down section pulling down the gate signal to an off voltage in response to one of the first clock signal and a second clock signal having an inverted phase relative to the first clock signal;
a driving section turning on and turning off the pull-up section and the pull-down section;
a holding section maintaining a voltage of the first node at the off voltage in response to the first clock signal; and
a voltage maintenance section delaying a voltage drop of the first node.

13. The display apparatus of claim 12, wherein the gate driving circuit comprises:
a first gate driving circuit comprising odd-numbered stages; and
a second gate driving circuit comprising even-numbered stages.

14. The display apparatus of claim 13, wherein the first clock signal that is input to the second gate driving circuit is delayed by a half period with respect to the first clock signal that is input to the first gate driving circuit.

15. The display apparatus of claim 14, wherein the driving section comprises:
a pull-up driving section turning on and turning off the pull-up section; and
a pull-down driving section turning off the pull-down part and the holding section in response to a signal of the first node,
wherein the pull-up driving section comprises a first pull-up driving part outputting the first voltage to the first node in response to the first input signal and a second pull-up driving part outputting a second voltage to the first node in response to the second input signal.

16. The display apparatus of claim 15, wherein the second voltage is the gate-on voltage of a low level when the first voltage is a gate-on voltage of a high level, and
the second voltage is the gate-on voltage of a high level when the first voltage is the gate-on voltage of a low level.

17. The display apparatus of claim 16, wherein the gate driving circuit outputs the gate signal from the stage of which ‘m’ is small when the first voltage is the gate-on voltage of a high level, and
the gate driving circuit outputs the gate signal from the stage of which ‘m’ is large when the second voltage is the gate-on voltage of a high level.

18. The display apparatus of claim 17, wherein the voltage maintenance section comprises:
a capacitor charging an input node of the first pull-up driving part, the second pull-up driving part, and the holding section with one of the first voltage and the second voltage in response to one of the first input signal and the second input signal; and
a plurality of transistors discharging the first voltage or the second voltage charged in the capacitor.

19. The display apparatus of claim 18, wherein the capacitor comprises:
a first electrode connected to the input node of the first pull-up driving part, the input node of the second pull-up driving part, and the input node of the holding section; and
a second electrode connected an off voltage terminal receiving the off voltage.

20. The display apparatus of claim 19, wherein the plurality of transistors comprise:
a first transistor comprising a control electrode receiving the first input signal, an input electrode receiving the first voltage, and an output electrode connected to the input node of the first pull-up driving part;
a second transistor comprising a control electrode receiving the second input signal, an input electrode receiving the second voltage, and an output electrode connected to the input node of the second pull-up driving part; and
a third transistor comprising a control electrode receiving the first clock signal, an input electrode receiving the off voltage, and an output electrode connected to the input node of the holding section.
